(19) United States
(12) Patent Application Publication
(10) Pub. No.: US 2016/0200413 A1
(43) Pub. Date: Jul. 14, 2016

(54) LUBRICATION FOR MARINE DRIVE SYSTEMS

(71) Applicant: Caterpillar Inc., Peoria, IL (US)

(72) Inventor: Patrick J. McDonald, Simpsonville, SC (US)

(73) Assignee: Caterpillar Inc., Peoria, IL (US)

(21) Appl. No.: 15/073,688

(22) Filed: Mar. 18, 2016

(51) Int. Cl. B63H 21/38; F16H 57/04

(52) U.S. Cl. CPC B63H 21/386; F16H 57/0435; F16H 57/043

(57) ABSTRACT

An oil return circuit for a marine drive system, is provided. The oil return circuit includes an oil collection chamber, a first drive shaft with a first air-vent hole, a second drive shaft with a second air-vent hole and third air-vent holes, and a cover adapter. The second air-vent hole is fluidly connected to the first vertical air-vent hole. The third air-vent holes are fluidly connected to the second air-vent hole and the oil collection chamber. The cover adapter includes a first flow passage defined between the first drive shaft and the cover adapter, a second flow passage, and third flow passages. The second flow passage includes a first hole and a second hole. The second hole is fluidly connected to the first hole and the oil collection chamber. The third flow passages are fluidly connected to the first hole and the oil collection chamber.

### TECHNICAL FIELD

The present disclosure relates generally to lubrication of marine drive systems. More specifically, the present disclosure relates to an oil return circuit for the marine drive system, to return lubrication oil from a first transmission unit to a second transmission unit.

### BACKGROUND

Marine machines, such as marine pods, are commonly known to employ a marine drive system, to propel and maneuver the marine machine forward in water. The marine drive system typically includes an engine, an inboard transmission unit, a first drive shaft, a second drive shaft, an underwater transmission unit, and a propeller. The engine and the inboard transmission unit are mounted within a hull of the marine machine. The underwater transmission unit and the propeller are mounted in a steerable case, below the hull of the marine machine. The inboard transmission unit is operably connected to the underwater transmission unit, with use of the first drive shaft and the second drive shaft. In general, the engine drives the inboard transmission unit, which in turn drives the underwater transmission unit, via the first drive shaft and the second drive shaft. The underwater transmission unit then drives a propeller shaft, which rotates the propeller of the marine machine, to maneuver the marine machine.

Furthermore, the marine drive system employs a lubrication system and an oil return circuit, to lubricate various components of the inboard transmission unit and the outboard transmission unit. The lubrication system includes a fluid pump that pumps lubrication oil from the underwater lubrication unit to the inboard lubrication unit. Additionally, the marine drive system employs the oil return circuit, to return lubrication oil from the inboard transmission unit to the underwater transmission unit.

Conventional oil return circuits include an oil collection chamber and a castle shaped cover adapter. The oil collection chamber is fluidly connected to the underwater transmission unit. The cover adapter defines one or more radial flow passage and one or more inclined flow passage, to return lubrication oil from the inboard transmission unit to oil collection chamber, which in turn returns lubrication oil to the underwater transmission unit. The radial flow passages are in fluid communication with the inboard transmission unit and the inclined flow passages are in fluid communication with the oil collection chamber. The lubrication oil flows from the inboard transmission unit to the oil collection chamber of the underwater transmission unit, via the radial flow passage and the inclined flow passage. However, a narrow cross-section of the radial flow passages and the inclined flow passages makes it inefficient to return entire lubrication oil from the inboard transmission unit to the oil collection chamber. Additionally, air is sometimes trapped in the oil collection chamber, which restricts a return flow of the lubrication oil, through the radial flow passages and the inclined flow passages. This results in overfilling of the inboard transmission unit and starves the fluid pump of the lubrication oil, resulting in fluid pump breakdown.

U.S. Pat. No. 8,979,603 discloses a lubrication system for lubricating various components of a watercraft propulsion system. The lubrication system supplies lubrication oil from a crankcase to various components through lubricant passages defined in a crankshaft, using a fluid pump. Additionally, the lubrication oil is returned back to the crankcase, though return passages defined in the crankshaft. However, air may still be trapped in the crankcase, which may restrict return flow of the lubrication oil through the return passages.

Accordingly, the system and method of the present disclosure solves one or more problems set forth above and other problems in the art.

### SUMMARY OF THE INVENTION

Various aspects of the present disclosure describe a marine drive system. The marine drive system includes a first transmission unit, a second transmission unit, a lubrication system, and an oil return circuit. The second transmission unit is operably connected to the first transmission unit. The lubrication system includes a lubrication pump and a suction tube. The lubrication pump is fluidly connected to the second transmission unit. In addition, the lubrication pump is fluidly connected to the first transmission unit, via the suction tube. The lubrication pump is adapted to pump lubrication oil from the second transmission unit to the first transmission unit. The oil return circuit is adapted to return lubrication oil from the first transmission unit to the second transmission unit. The oil return circuit is adapted to return lubrication oil from the first transmission unit to the second transmission unit. The oil return circuit includes an oil collection chamber, a first drive shaft, a second drive shaft, and a cover adapter. The oil collection chamber is in fluid communication with the second transmission unit. The first drive shaft extends from the first transmission unit. The first drive shaft includes a first air-vent hole. The second drive shaft extends from the second transmission unit and is attached to the first drive shaft. The second drive shaft includes a second air-vent hole and third air-vent holes. Each of the third air-vent holes extends from and is fluidly connected to the second air-vent hole. The second air-vent hole is in fluid communication with the first air-vent hole. The third air-vent holes are in fluid communication with the oil collection chamber. The cover adapter is adapted to cover a portion of the first drive shaft and a portion of the second drive shaft. The cover adapter includes a first flow passage, two second flow passages, and two third flow passages. Each of the first flow passage, the second flow passages, and the third flow passages include a cross-sectional area greater than a cross-sectional area of the suction tube. The first flow passage is defined between an outer periphery of the first drive shaft and an inner periphery of the cover adapter. The first flow passage is fluidly connected to the first transmission unit. Each of the second flow passages includes a first hole and a second hole. The first hole is in fluid communication with the first flow passage. The second hole is fluidly connected to the first hole and the oil collection chamber. Each of the third flow passages is fluidly connected to the first hole and the oil collection chamber.

### BRIEF DESCRIPTION OF THE DRAWINGS

FIG. 1 is a schematic of a portion of a marine machine that illustrates a marine drive system for propelling the marine machine, in accordance with the concepts of the present disclosure;

FIG. 2 is a sectional view of a portion of the marine drive system of FIG. 1 that includes an oil return circuit, illustrating a second flow passage of a cover adapter of the oil return circuit; and

FIG. 3 is another sectional view of the portion of the marine drive system of FIG. 1 that includes the oil return circuit, illustrating a third flow passage of the cover adapter of the oil return circuit.

### DETAILED DESCRIPTION

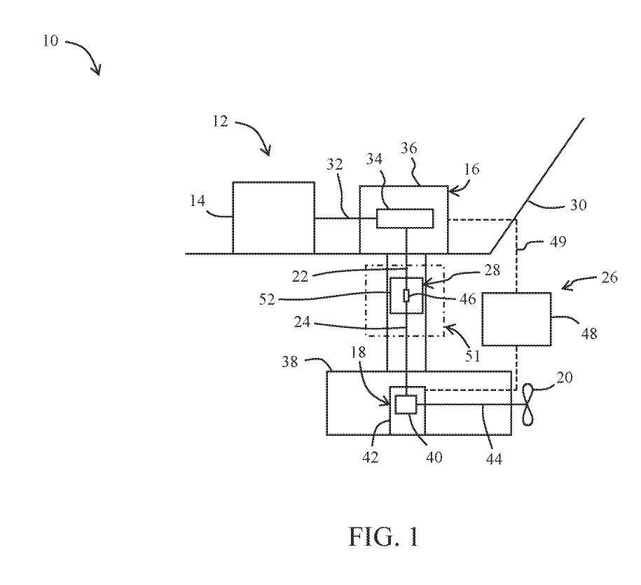

Referring to FIG. 1, there is shown a marine drive system 12 for a marine machine 10, in accordance with the concepts of the present disclosure. Examples of the marine machine 10 may include, such as but not limited to, boats, ships, and oilrigs. The marine drive system 12 is adapted to propel and maneuver the marine machine 10 in water. The marine drive system 12 includes a prime mover 14, a first transmission unit 16, a second transmission unit 18, a propeller 20, a first drive shaft 22, a second drive shaft 24, a lubrication system 26, and an oil return circuit 28.

The prime mover 14 is generally mounted within a hull 30 of the marine machine 10. The prime mover 14 is adapted to generate torque required to propel the marine machine 10. Torque produced by the prime mover 14 is transferred to the propeller 20, to propel the marine machine 10 forward. More specifically, torque produced by the prime mover 14 is transferred to the propeller 20, via the first transmission unit 16 and the second transmission unit 18. Examples of the prime mover 14 may include, such as but not limited to, an engine, an electric motor, a hydraulic motor, a pneumatic motor, and a crank shaft mechanism.

The first transmission unit 16 is an inboard transmission unit, mounted within the hull 30 of the marine machine 10. The first transmission unit 16 is connected to and is driven by the prime mover 14, via a transmission input shaft 32. The first transmission unit 16 includes a first bevel gear assembly 34 positioned in a first transmission chamber 36. The first bevel gear assembly 34 is connected to the transmission input shaft 32 and is adapted to transmit torque from the transmission input shaft 32 to the second transmission unit 18. An arrangement between the first transmission unit 16 and the second transmission unit 18 will be explained later in detail.

The second transmission unit 18 is an underwater transmission unit, mounted exterior to the hull 30, within an underwater structure 38 of the marine machine 10. The second transmission unit 18 is connected to and is driven by the first transmission unit 16. The second transmission unit 18 includes a second bevel gear assembly 40 positioned in a second transmission chamber 42. In general, lubrication oil is stored in the second transmission chamber 42, to lubricate the second bevel gear assembly 40 of the second transmission unit 18. The second bevel gear assembly 40 of the second transmission unit 18 is adapted to transmit torque from the first transmission unit 16 to a horizontally disposed propeller shaft 44.

The propeller 20 of the marine drive system 12 is connected to and is driven by the propeller shaft 44 of the marine drive system 12. The propeller 20 is adapted to receive torque from the propeller shaft 44 and therefore rotate, to propel the marine machine 10 forward. More specifically, a rotational motion of the propeller 20 corresponds to a drag force on the marine machine 10, which causes the marine machine 10 to move forward in water.

The first transmission unit 16 is connected to the second transmission unit 18, via the first drive shaft 22 and the second drive shaft 24. In general, the first drive shaft 22 extends vertically from the first bevel gear assembly 34 of the first transmission unit 16. The second drive shaft 24 extends vertically from the second bevel gear assembly 40 of the second transmission unit 18. The first drive shaft 22 and the second drive shaft 24 are fixedly connected with each other, via a sleeve arrangement 46.

Furthermore, the marine drive system 12 employs the lubrication system 26, to lubricate both of the first bevel gear assembly 34 and the second bevel gear assembly 40. The lubrication system 26 includes a lubrication pump 48 and a suction tube 49. The lubrication pump 48 is fluidly connected to the second transmission chamber 42 of the second transmission unit 18. Additionally, the lubrication pump 48 is fluidly connected to the first transmission chamber 36 of the first transmission unit 16, via the suction tube 49. The suction tube 49 has a cross-sectional area, to allow a flow of lubrication oil through the suction tube 49. The lubrication pump 48 is adapted to pump and transfer lubrication oil from the second transmission chamber 42 to the first transmission chamber 36, to lubricate each of the first bevel gear assembly 34 and the second bevel gear assembly 40.

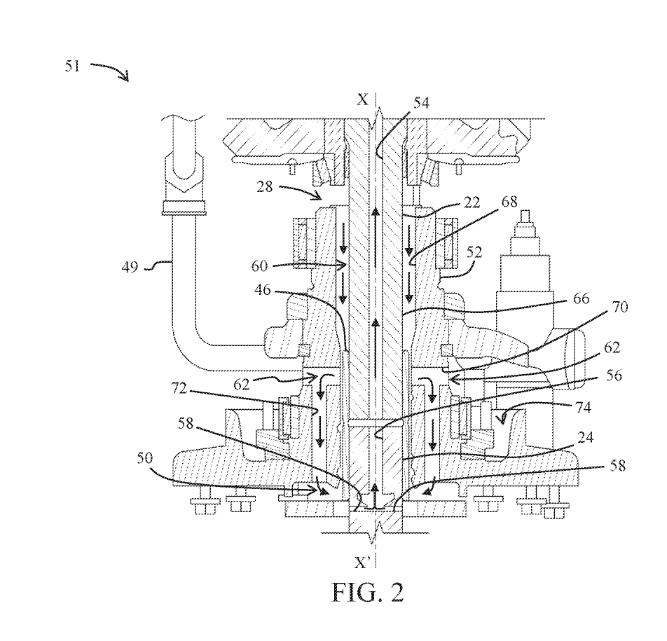

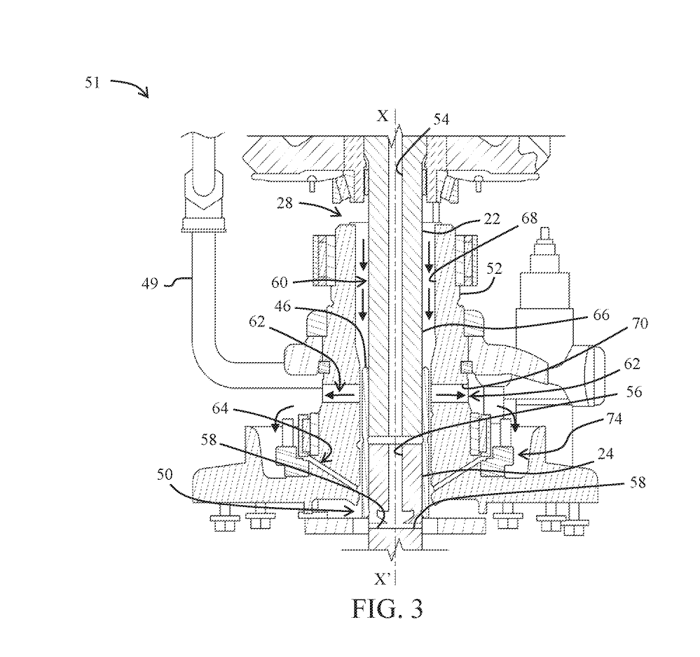

Referring to FIGS. 2 and 3, there is shown a portion 51 of the marine drive system 12 that illustrates the oil return circuit 28. The oil return circuit 28 is adapted to return lubrication oil back from the first transmission chamber 36 of the first transmission unit 16 to the second transmission chamber 42 of the second transmission unit 18. Additionally, the oil return circuit 28 is adapted to vent out air trapped in the second transmission chamber 42 of the second transmission unit 18 to external environment. The oil return circuit 28 includes an oil collection chamber 50, the first drive shaft 22, the second drive shaft 24, and a cover adapter 52.

The oil collection chamber 50 is defined within the underwater structure 38, below the cover adapter 52. The oil collection chamber 50 is in fluid communication with the second transmission chamber 42 of the second transmission unit 18. In general, lubrication oil from the first transmission chamber 36 of the first transmission unit 16 is returned to the oil collection chamber 50, from where it is supplied to the second transmission chamber 42. A connection between the oil collection chamber 50 and the second transmission chamber 42 is facilitated via a fluid attachment means, such as but not limited to, pipes, hoses, and conduits.

The first drive shaft 22 includes a first air-vent hole 54. The first air-vent hole 54 is a gun drilled through hole that extends through a length of the first drive shaft 22, along a vertical axis X-X′, The first air-vent hole 54 is in fluid communication with external environment. Although, the first air-vent hole 54 is envisioned to be gun drilled along the length of the first drive shaft 22, various other processes to form the first air-vent hole 54 may be contemplated, such as but not limited to, deep hole drilling, trepanning, micro-drilling, and boring.

The second drive shaft 24 includes a second air-vent hole 56 and two third air-vent holes 58. Each of the second air-vent hole 56 and the third air-vent holes 58 are defined within the second drive shaft 24. The second air-vent hole 56 is a gun drilled hole, defined along a length of the second drive shaft 24, along the vertical axis X-X′, The second air-vent hole 56 is in fluid communication with the first air-vent hole 54 of the first drive shaft 22. The third air-vent holes 58 extends radially from and fluidly connects to the second air-vent hole 56. Additionally, the third air-vent holes 58 are in fluid communication with the oil collection chamber 50. In general, air trapped in the oil collection chamber 50 is vented to the external environment, via the third air-vent hole 58, the second air-vent hole 56, and the first air-vent hole 54.

The cover adapter 52 is a castle shaped member disposed within the underwater structure 38. The cover adapter 52 is adapted to cover a portion of the first drive shaft 22 and a portion of the second drive shaft 24. The cover adapter 52 includes a first flow passage 60, two second flow passages 62, and two third flow passages 64. Each of the first flow passage 60, the second flow passages 62, and the third flow passages 64 include a cross-sectional area relatively greater than the cross-sectional area of the suction tube 49. Although, structure and arrangement of a singular second flow passage 62 and a singular third flow passage 64 with the first flow passage 60, will be explained hereinafter, However, similar structure and arrangement of the other second flow passage 62 and the other third flow passage 64, with the first flow passage 60, may also be contemplated.

The first flow passage 60 is defined between an outer periphery 66 of the first drive shaft 22 and an inner periphery 68 of the cover adapter 52. The first flow passage 60 is fluidly connected to the first transmission chamber 36 of the first transmission unit 16. A connection between the first flow passage 60 and the first transmission chamber 36 is facilitated via a fluid attachment means, such as but not limited to, pipes, hoses, and conduits.

The second flow passage 62 is defined within the cover adapter 52. The second flow passage 62 includes a first hole 70 and a second hole 72 (FIG. 2). The first hole 70 is a through hole defined radially within the cover adapter 52, extending from the first flow passage 60. More specifically, the first hole 70 is in fluid communication with the first flow passage 60. The second hole 72 (FIG. 2) extend vertically from the first hole 70 of the second flow passage 62, along a length of the cover adapter 52. More particularly, the second hole 72 (FIG. 2) is in fluid communication with the first hole 70 of the second flow passage 62, Additionally, the second hole 72 (FIG. 2) is in fluid communication with the oil collection chamber 50.

Similar to the second flow passage 62, the third flow passage 64 (FIG. 3) is also defined within the cover adapter 52. The third flow passage 64 (FIG. 3) is an inclined flow passage fluidly connected to the first hole 70 of the second flow passage 62, via a collection compartment 74. More specifically, the first hole 70 of the second flow passage 62 is in fluid communication with the collection compartment 74 and the third flow passage 64 extend from the collection compartment 74, to facilitate a fluid communication between the second flow passage 62 and the third flow passage 64 (FIG. 3). Moreover, the third flow passage 64 (FIG. 3) is in fluid communication with the oil collection chamber 50.

### INDUSTRIAL APPLICABILITY

In operation, the second transmission chamber 42 of the second transmission unit 18 carries lubrication oil, to lubricate the second bevel gear assembly 40 of the second transmission unit 18. The lubrication pump 48 of the lubrication system 26 is actuated, to lubricate the first bevel gear assembly 34 of the first transmission unit 16. The lubrication pump 48 then pumps lubrication oil from the second transmission chamber 42 and supply to the first transmission chamber 36. This facilitates lubrication of the first bevel gear assembly 34 of the first transmission unit 16.

In order to facilitate continuous flow of lubrication oil, the oil return circuit 28 returns lubrication oil from the first transmission chamber 36 to the second transmission chamber 42 of the second transmission unit 18. Lubrication oil flows from the first transmission chamber 36 to the second transmission chamber 42, via the first flow passage 60, the second flow passage 62, the third flow passage 64, and the oil collection chamber 50 of the oil return circuit 28. In general, the first flow passage 60 receive lubrication oil from the first transmission chamber 36 of the first transmission unit 16, From the first flow passage 60, lubrication oil flows to the first hole 70 of the second flow passage 62. Thereafter, a portion of the lubrication oil flows from the first hole 70 to the oil collection chamber 50, through the second hole 72 of the second flow passage 62. The remaining lubrication oil flows from the first hole 70 to the oil collection chamber 50, through the third flow passage 64. From the oil collection chamber 50, lubrication oil then flows to the second transmission chamber 42 of the second transmission unit 18. As the lubrication oil flows from each of the second. hole 72 of the second flow passage 62 and the third flow passage 64, the oil return circuit 28 is relatively more efficient, to return lubrication oil from the first transmission chamber 36 to the second transmission chamber 42. Additionally, each of the first flow passage 60, the second flow passage 62, and the third flow passage 64 has a relatively greater cross-sectional area than the suction tube 49 of the lubrication system 26. This adds to increase in overall efficiency of the oil return circuit 28, to return lubrication oil from the first transmission chamber 36 of the first transmission unit 16 to the second transmission chamber 42 of the second transmission unit 18.

Furthermore, the air trapped in the second transmission chamber 42 is vented to the external environment, through the oil collection chamber 50, the third air-vent hole 58, the second air-vent hole 56, and the first air-vent hole 54. This adds to increase in the overall efficiency of the oil return circuit 28, to return lubrication oil from the first transmission chamber 36 of the first transmission unit 16 to the second transmission chamber 42 of the second transmission unit 18.

The many features and advantages of the disclosure are apparent from the detailed specification, and thus, it is intended by the appended claims to cover all such features and advantages of the disclosure that fall within the true spirit and scope thereof. Further, since numerous modifications and variations will readily occur to those skilled in the art. It is not desired to limit the disclosure to the exact construction and operation illustrated and described, and, accordingly, all suitable modifications and equivalents may be resorted to that fall within the scope of the disclosure.

What is claimed is:

11. A marine drive system, comprising:
a first transmission unit;
a second transmission unit operably connected to the first transmission unit;
a lubrication system including a lubrication pump and a suction tube, the lubrication pump being fluidly connected to the second transmission unit, the lubrication pump being fluidly connected to the first transmission unit via the suction tube; the lubrication pump being adapted to pump lubrication oil from the second transmission unit to the first transmission unit; and
an oil return circuit adapted to return lubrication oil from the first transmission unit to the second transmission unit, the oil return circuit including:
an oil collection chamber in fluid communication with the second transmission unit;
a first drive shaft extending from the first transmission unit and including a first air-vent hole;
a second drive shaft extending from the second transmission unit and attached to the first drive shaft, the second drive shaft including a second air-vent hole and at least one third air-vent hole extending from and fluidly connected to the second air-vent hole,
wherein the second air-vent hole is in fluid communication with the first air-vent hole, the at least one third air-vent hole is in fluid communication with the oil collection chamber; and
a cover adapter adapted to cover at least a portion of the first drive shaft and at least a portion of the second drive shaft, the cover adapter including a first flow passage, at least one second flow passage, and at least one third flow passage, each of the first flow passage, the at least one second flow passage, and the at least one third flow passage including a cross-sectional area greater than a cross-sectional area of the suction tube,
wherein, the first flow passage is defined between an outer periphery of the first drive shaft and an inner periphery of the cover adapter, the first flow passage being fluidly connected to the first transmission unit,
wherein the at least one second flow passage includes a first hole and a second hole, the first hole being in fluid communication with the first flow passage, the second hole being fluidly connected to the first hole and the oil collection chamber,
wherein the at least one third flow passage is fluidly connected to the first hole and the oil collection chamber.
